(19) United States
(12) Patent Application Publication
(10) Pub. No.: US 2021/0149766 A1
(43) Pub. Date: May 20, 2021

(54) SUPERVISED REIMAGING OF VULNERABLE COMPUTING DEVICES WITH PRIORITIZATION, AUTO HEALING, AND PATTERN DETECTION

(71) Applicant: MICROSOFT TECHNOLOGY LICENSING, LLC, Redmond, WA (US)

(72) Inventors: Muthukumaran ARUMUGAM, Redmond, WA (US); Tanmoy Dasgupta, Redmond, WA (US); Tom W. Tseng, Redmond, WA (US); Mark R. Gilbert, Issaquah, WA (US); Lane A. Schafer, Carnation, WA (US)

(21) Appl. No.: 16/685,947

(22) Filed: Nov. 15, 2019

(51) Int. Cl. G06F 11/14; G06F 11/07; G06F 8/61; G06F 9/48

(52) U.S. Cl. CPC G06F 11/1433; G06F 11/076; G06F 9/4881; G06F 8/63; G06F 11/0793

(57) ABSTRACT

Technologies are disclosed for supervised reimaging of vulnerable computing devices with prioritization, auto healing, and pattern detection. A system for re-imaging computing devices includes a scheduler that implements a workflow for reimaging computing devices using software agents. The system also includes a supervisor that monitors state data to determine if the reimaging workflow has failed for any computing devices and for initiating an auto heal job for remediating failure of the re-imaging workflow. The system also includes a vulnerability manager that can perform various operations with respect to computing devices for which a reimaging workflow has failed a predetermined number of times. The vulnerability manager might also, or alternately, identify failure patterns (e.g. multiple instances of a reimaging workflow failing for the same reason) and initiate various actions based upon the identified patterns.

### BACKGROUND

In order for computing devices to operate with a high level of security, it is imperative that security patches that remedy software vulnerabilities be applied in a timely manner. Security patches can be easily applied to vulnerable computing devices on a small scale. However, it can be extremely complex to apply security patches to vulnerable computing devices on a very large scale. For example, modern data centers can have tens or even hundreds of thousands of server computers. In these environments, the process for applying security updates can be complex and, as a result, can be error prone.

Errors occurring during the process of applying security updates to server computers (a process that might be referred to herein as “reimaging”) can cause serious operational issues. For example, errors occurring during reimaging can cause server computers to remain out of service for extended periods of time. As another example, a failed reimaging of a server computer might have to be restarted from the beginning or might be unnecessarily repeated on the same computer, thereby wasting computing resources unnecessarily. Moreover, server computers vulnerable to attacks might not be patched quickly enough, thereby increasing their vulnerability to malicious attacks.

It is with respect to these and other technical challenges that the disclosure made herein is presented.

### SUMMARY

Technologies are disclosed herein for supervised reimaging of vulnerable computing devices with prioritization, auto healing, and pattern detection. Through implementations of the disclosed technologies, failures that occur during the reimaging of computing devices, such as server computers, can be prevented or quickly remediated, thereby maximizing the up time of these devices, conserving computing resources, and improving security. Technical benefits other than those specifically identified herein might also be realized through implementations of the disclosed technologies.

In one embodiment, a system for re-imaging computing devices includes a scheduler. The scheduler implements a workflow for reimaging computing devices, such as server computers. As discussed above, the reimaging workflow includes, among other things, installing security patches (which might also be referred to herein as “security updates” or “software patches”) that address security vulnerabilities on computing devices.

In one embodiment, the scheduler controls and coordinates the operation of software agents that implement steps of the reimaging workflow. For instance, software agents might provide functionality for vacating virtual machines (“VMs”) from the computing devices, performing quality checks on the computing devices, installing security patches, or installing other software components such as instrumentation components.

In some embodiments, the software agents provide status messages to the scheduler that include data describing various aspects of the status of the reimaging workflow. For instance, the status messages might indicate that a step in the reimaging workflow has started, completed, or failed. In turn, the scheduler stores the status messages in an appropriate data store for use by itself and other components, some of which are described below.

In some embodiments, the disclosed system also includes a supervisor. The supervisor monitors the state data stored in the data store to determine if the reimaging workflow has failed for any computing devices. If the workflow has failed for a computing device, the supervisor initiates an auto heal job for remediating failure of the re-imaging workflow for the computing device. The auto heal job determines the reason for the failure of the reimaging workflow and applies one or more actions in an attempt to remediate the identified failure.

If the auto heal job is successful, the failed reimaging workflow for the computing device can be resumed at the point in the workflow at which it terminated due to the failure. In this way, the reimaging workflow does not need to be restarted following a failure, thereby conserving the utilization of computing resources.

If the auto heal job is unsuccessful, the workflow for re-imaging the computing device is retried after a predefined period of time has elapsed. If the workflow for re-imaging the computing device fails a predetermined number of times, state data can be stored in the data store that specifies a reason, or reasons, for failure of the reimaging workflow, a date upon which the computing device last received a security update, and potentially other types of data.

The disclosed system also includes a vulnerability manager in some embodiments. The vulnerability manager can perform various operations with respect to computing devices for which the reimaging workflow has failed a predetermined number of times. For example, and without limitation, the vulnerability manager might shut down computing devices for which the reimaging process has failed a predetermined number of times or prevent network traffic from reaching the computing devices.

The vulnerability manager might also, or alternately, identify patterns (e.g. multiple instances of the reimaging workflow failing for the same reason) based upon the state data and initiate various actions based upon the identified patterns such as, for example, creating trouble tickets, generating alerts, or other types of reporting. The proper engineering team can then take action to remediate the failure. Once the failure of the reimaging workflow for these computing devices has been remediated, the state data for the computing devices can be updated to indicate that the devices are again available for application of the reimaging workflow to these devices in a typical fashion.

It should be appreciated that the subject matter disclosed herein can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing architecture diagram showing an overview of an illustrative configuration for a system for supervised reimaging of vulnerable computing devices, according to one embodiment;

FIG. 2A is a computing architecture diagram illustrating aspects of the operation of a scheduler utilized in embodiments disclosed herein;

FIG. 2B is a flow diagram showing a routine that illustrates aspects of the operation of the scheduler shown in FIG. 2A, according to one embodiment disclosed herein;

FIG. 3A is a computing architecture diagram illustrating aspects of the operation of a supervisor utilized in embodiments disclosed herein;

FIG. 3B is a flow diagram showing a routine that illustrates aspects of the operation of the supervisor shown in FIG. 3A, according to one embodiment disclosed herein;

FIG. 4A is a computing architecture diagram illustrating additional aspects of the operation of the supervisor shown in FIG. 3A;

FIG. 4B is a flow diagram showing a routine that illustrates additional aspects of the operation of the supervisor shown in FIGS. 3A and 4A, according to one embodiment disclosed herein;

FIG. 5A is a computing architecture diagram illustrating aspects of the operation of a vulnerability manager, according to one embodiment disclosed herein;

FIG. 5B is a flow diagram showing a routine that illustrates additional aspects of the operation of the vulnerability manager shown in FIG. 5A, according to one embodiment disclosed herein;

FIG. 6 is a computer architecture diagram illustrating an illustrative computer hardware and software architecture for a computing system capable of implementing aspects of the techniques and technologies presented herein;

FIG. 7 is a network diagram illustrating an illustrative distributed computing environment capable of implementing aspects of the techniques and technologies presented herein; and

FIG. 8 is a computer architecture diagram illustrating a computing device architecture for a computing device capable of implementing aspects of the techniques and technologies presented herein.

### DETAILED DESCRIPTION

The following detailed description is directed to technologies for supervised reimaging of vulnerable computing devices with prioritization, auto healing, and pattern detection. As discussed briefly above and in greater detail below, implementations of the disclosed technologies can prevent or quickly remediate failures that occur during the reimaging of computing devices, thereby maximizing the up time of these devices, conserving computing resources, and improving security. Other technical benefits not specifically identified herein can also be realized through implementations of the disclosed technologies.

While the subject matter described herein is primarily presented in the context of the reimaging of server computers in a data center, those skilled in the art will recognize that the disclosed technologies can be utilized to reimage other types of computing devices in other types of environments. Those skilled in the art will also appreciate that the subject matter described herein can be practiced with various computer system configurations, including hand-held devices, multiprocessor systems, microprocessor-based or programmable consumer electronics, computing or processing systems embedded in devices (such as wearable computing devices, automobiles, home automation etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for supervised reimaging of vulnerable computing devices with prioritization, auto healing, and pattern detection will be described.

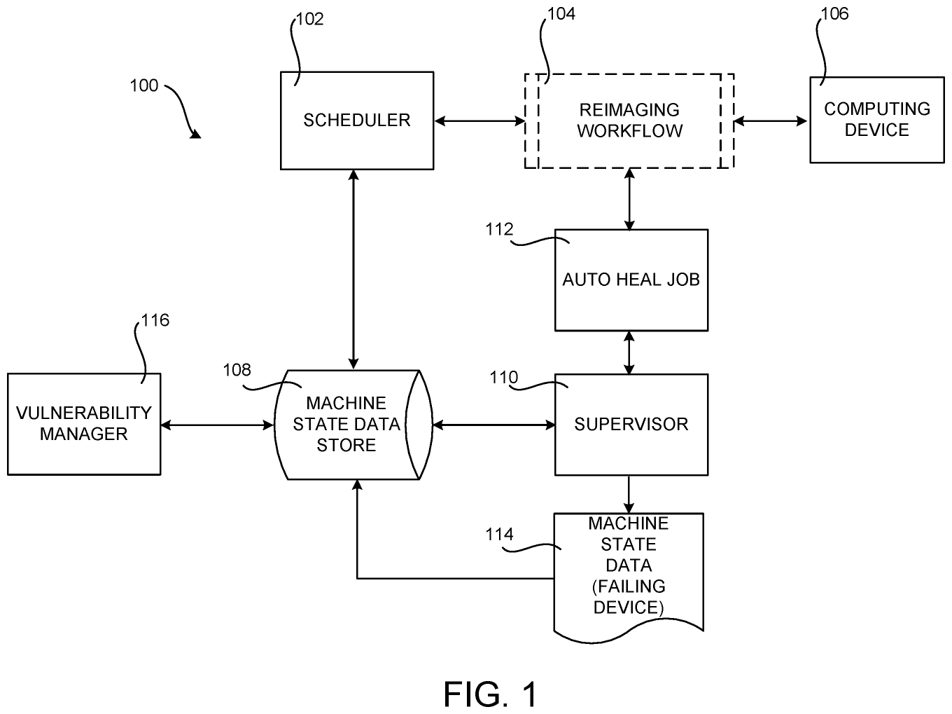

FIG. 1 is a computing architecture diagram showing an overview of an illustrative configuration for a system 100 for supervised reimaging of vulnerable computing devices, according to one embodiment. As discussed briefly above, the disclosed system 100 for re-imaging computing devices includes a scheduler 102 in some embodiments. The scheduler 102 is a software component that implements a reimaging workflow 104 for reimaging computing devices 106, such as server computers.

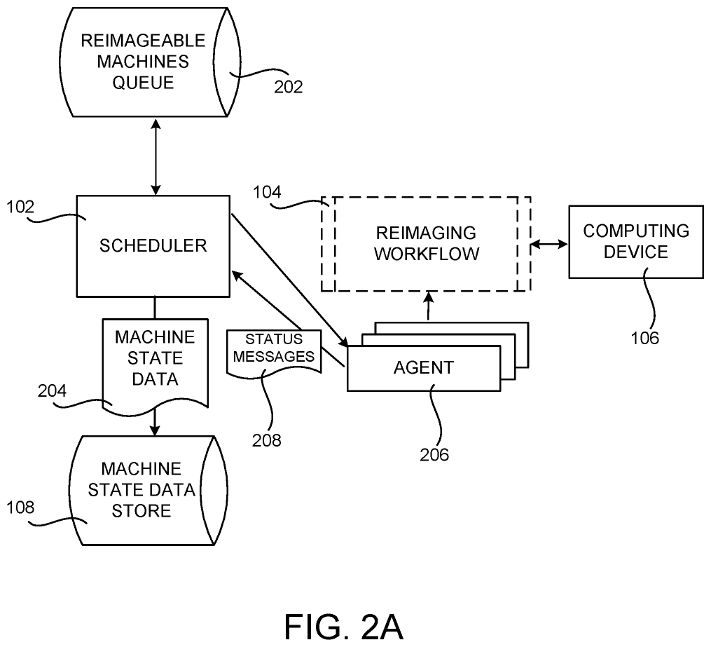

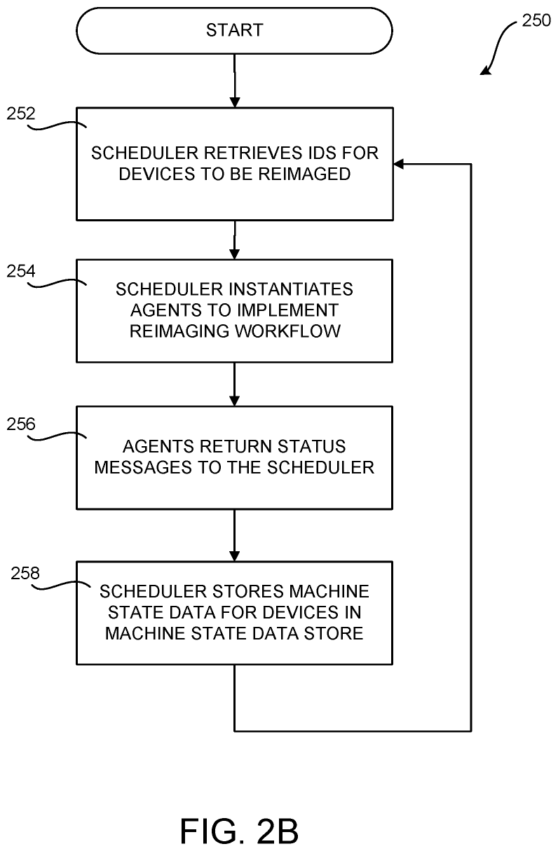

As also discussed above, the reimaging workflow 104 can include, among other things, installing security patches (which might also be referred to herein as “security updates” or “software patches”) that address security vulnerabilities on computing devices 106, preferably within a predetermined amount of time (e.g. one month from the time a security patch becomes available). Accordingly, the computing devices 106 might be referred to herein as “vulnerable computing devices 106” or “vulnerable devices 106.” In this regard, it is to be appreciated that while the embodiments disclosed herein are described primarily in the context of reimaging server computers, the technologies disclosed herein can be utilized to reimage other types of computing devices in a similar manner. Additional details regarding the operation of the scheduler 102 and the reimaging workflow 104 will be provided below with regard to FIGS. 2A and 2B.

In some embodiments, the system 100 also includes a supervisor 110. The supervisor 110 is a software component that monitors state data stored in a data store 108 (which might be referred to herein as the “data store 108” or the “machine state data store 108”) to determine if the reimaging workflow 104 has failed for any computing devices 106. If the workflow 104 has failed for a computing device 106, the supervisor 110 initiates an auto heal job 112 for remediating failure of the re-imaging workflow 104 for the computing device 106.

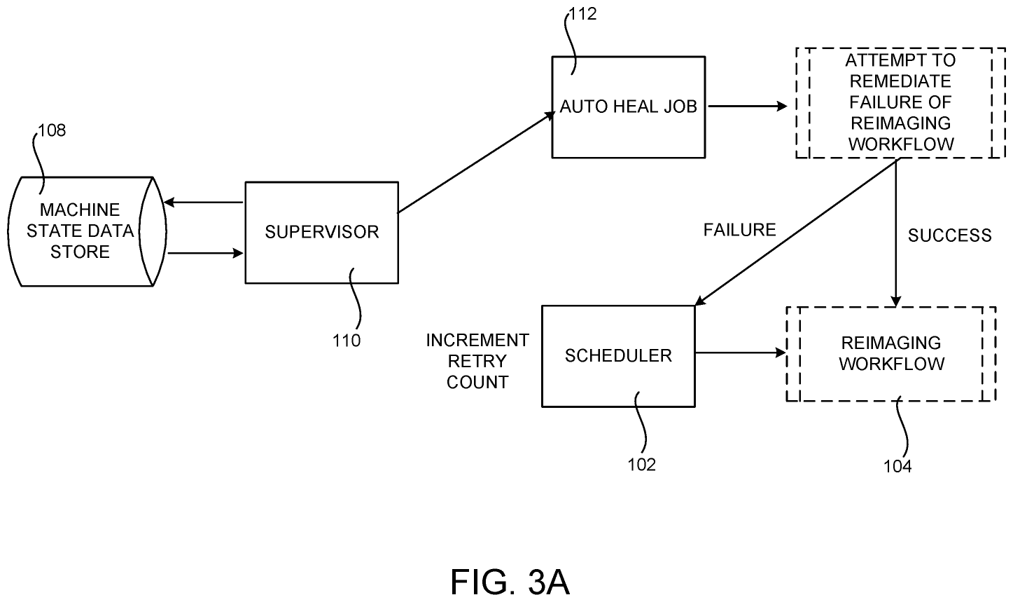

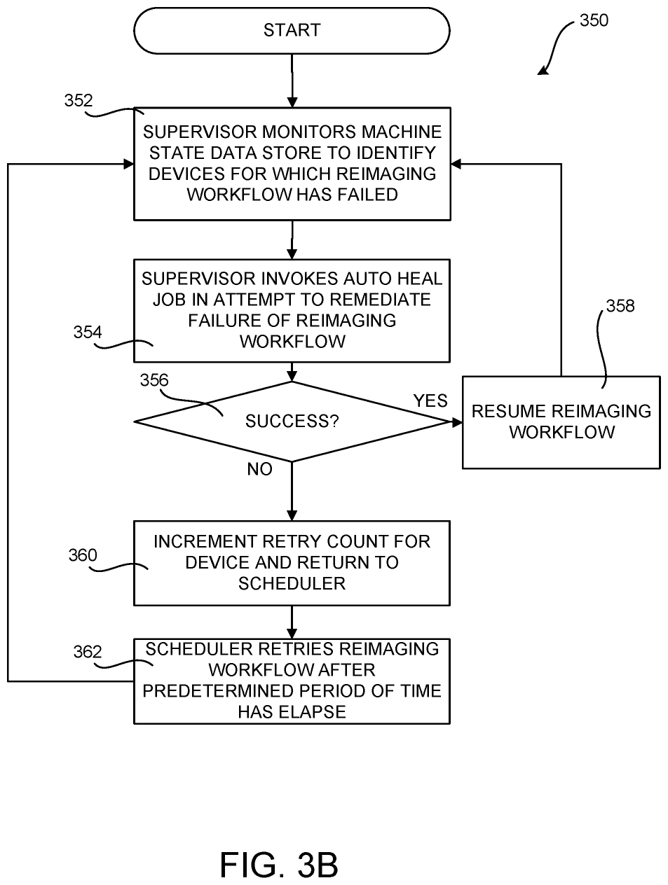

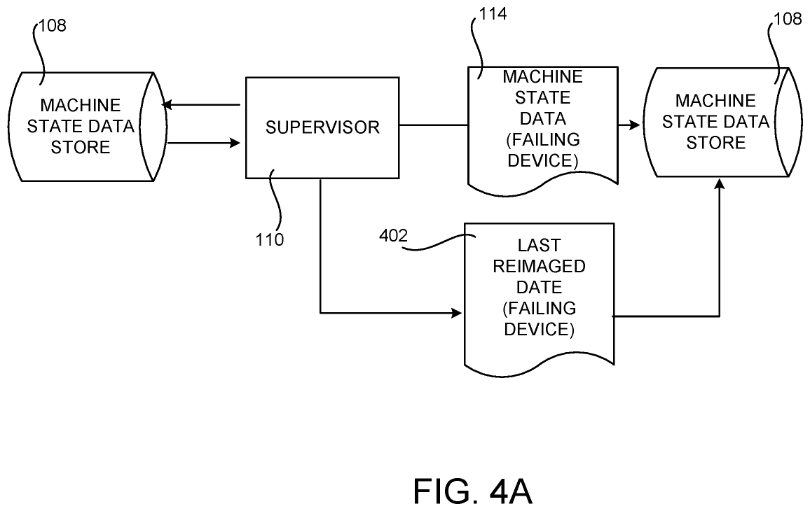

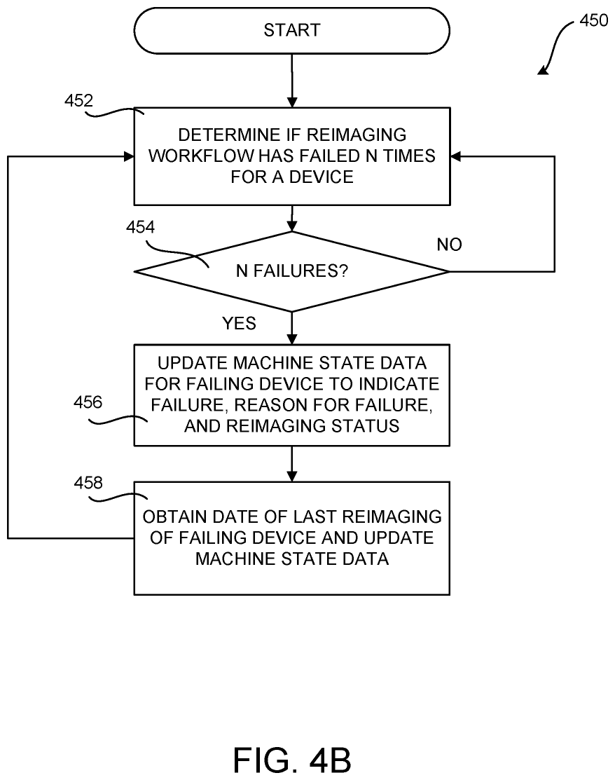

The auto heal job 112 determines the reason for the failure of the reimaging workflow 104 and applies one or more actions in an attempt to remediate the failure. If the workflow 104 for re-imaging a computing device 106 fails a predetermined number of times, the supervisor 110 can store state data 114 in the data store 108 that specifies a reason, or reasons, for failure of the reimaging workflow 104, a date upon which the computing device 106 last received a security update, and potentially other information. Additional details regarding the operation of the supervisor 110 and the auto heal job 112 will be provided below with regard to FIGS. 3A-4B.

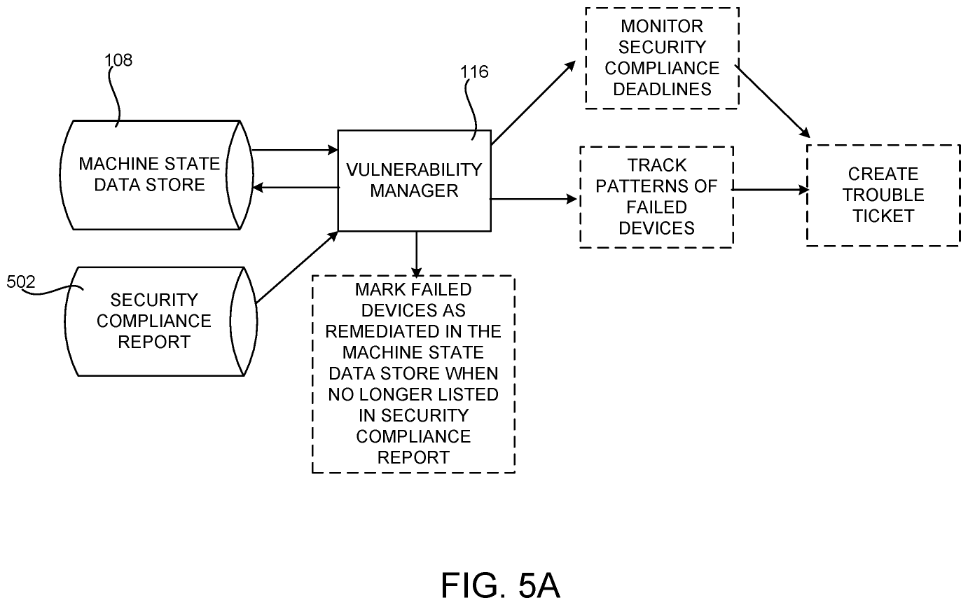

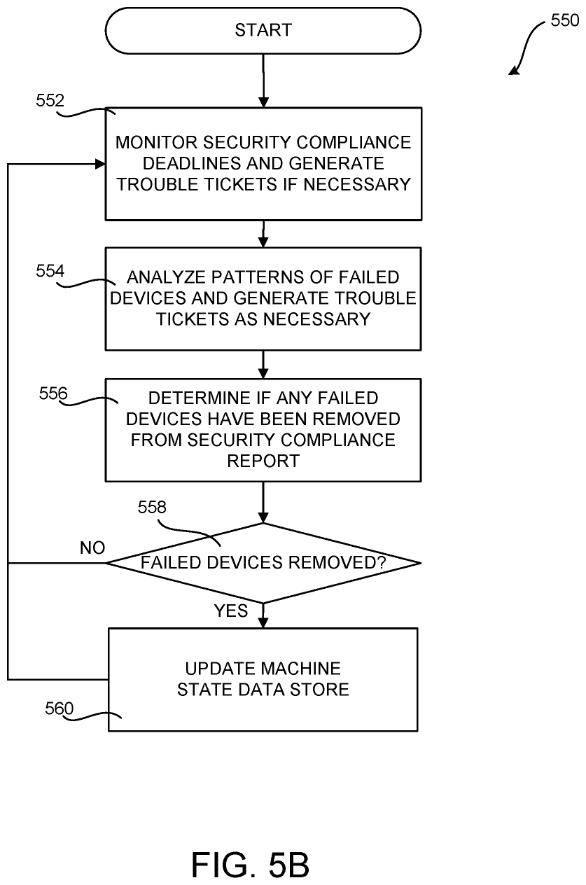

The system 100 also includes a vulnerability manager 116 in some embodiments. The vulnerability manager 116 is a software component that can perform various operations with respect to computing devices 106 for which the reimaging workflow 104 has failed a predetermined number of times. For example, and without limitation, the vulnerability manager 116 might shut down computing devices 106 for which the reimaging workflow 104 has failed a predetermined number of times or remove network traffic from the computing devices 106. Additional details regarding the operation of the vulnerability manager are provided below with regard to FIGS. 5A and 5B.

FIG. 2A is a computing architecture diagram illustrating additional aspects of the operation of a scheduler 102 utilized in embodiments disclosed herein. As discussed briefly above, the scheduler 102 is a software component that implements a reimaging workflow 104 for reimaging computing devices 106, such as server computers. As also discussed above, the reimaging workflow 104 can include, among other things, installing security patches that address security vulnerabilities on computing devices 106. The reimaging workflow 104 can also include performing other operations on the computing devices 106 prior or subsequent to the installation of the security patches. Some of these operations will be describe below.

In one embodiment, the scheduler 102 controls and coordinates the operation of software agents 206 (which might be referred to herein as “agents”) that implement steps of the reimaging workflow 104. For instance, the agents 206 might provide functionality for vacating (i.e. removing) virtual machines (“VMs”) from the computing devices 106, performing quality checks on the computing devices 106, installing the security patches, or installing other software components such as operating system, security, or instrumentation components. Quality checks might include, for example, determining if a dynamic host configuration protocol (“DHCP”) reservation having the correct media access control (“MAC”) address is present on a DHCP server, determining whether the serial number of a computing device 106 is the same as that stored in an asset management system, or determining whether the hardware of the computing device 106 is healthy enough for reimaging. Other types of quality checks might also be performed.

In order to reimage the computing devices 106, the scheduler 102 can retrieve identifiers (“IDs”) for computing devices 106 that are to be reimaged from a queue 202. The scheduler 102 can then give priority to the reimaging of computing devices 106 that suffer from security vulnerabilities as opposed to those that require reimaging for other non- security related purposes.

The scheduler 102 can also instantiate software agents 206 in order to implement the steps of the reimaging workflow 104 for the prioritized computing devices 106. As the agents 206 perform their respective tasks, the agents 206 can provide status messages 208 to the scheduler 102 that include state data 204 describing various aspects of the status of the reimaging workflow 104. For instance, the state data 204 might indicate that a step in the reimaging workflow 104 has started, completed, or failed.

In turn, the scheduler 102 stores the state data 204 in an appropriate data store 108 for use by itself and other components, some of which are described below. The scheduler 102 can also instantiate other agents 206 based on the state data 204. For instance, the scheduler 102 might start a new agent 206 when another agent 206 indicates that it has completed its operation successfully.

FIG. 2B is a flow diagram showing a routine 250 that illustrates aspects of the operation of the scheduler 102 shown in FIGS. 1 and 2A, according to one embodiment disclosed herein. It should be appreciated that the logical operations described herein with regard to FIG. 2B, and the other FIGS., can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein. It should also be understood that the methods described herein can be ended at any time and need not be performed in their entireties.

Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules might be implemented in software, in firmware, in special purpose digital logic, and any combination thereof

As described herein, in conjunction with the FIGS. described herein, the operations of the routine 250 are described herein as being implemented, at least in part, by an application, component, and/or circuit. Although the following illustration refers to the components of FIGS. 1 and 2A, it can be appreciated that the operations of the routine 250 might be also implemented in many other ways. For example, the routine 250 might be implemented, at least in part, by a computer processor or a processor or processors of another computer. In addition, one or more of the operations of the routine 250 might alternatively or additionally be implemented, at least in part, by a computer working alone or in conjunction with other software modules.

For example, the operations of routine 250 (and the operations illustrated in the other FIGS.) are described herein as being implemented, at least in part, by an application, component, and/or circuit, which are generically referred to herein as modules. In some configurations, the modules can be a dynamically linked library (“DLL”), a statically linked library, functionality produced by an application programing interface (“API”), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

The routine 250 begins at operation 252, where the scheduler 102 retrieves IDs for the computing devices 106 that are to be reimaged. The routine 250 then proceeds from operation 252 to operation 254, where the scheduler 102 instantiates the software agents 206 to implement the reimaging workflow 104 in the manner described above.

From operation 254, the routine 250 proceeds to operation 256, where the agents 206 perform their respective tasks and return status messages that include state data 204 to the scheduler 102. As discussed above, the state data 204 describes various aspects of the status of the reimaging workflow 104. For instance, the state data 204 might indicate that a step in the reimaging workflow 104 has started, completed, or failed.

The scheduler 102 stores the state data 204 received from the agents 206 in the data store 108 at operation 258. Other components in the system 100 can utilize the state data 204 in various ways, some of which will be described in detail below. From operation 258, the routine 250 proceeds back to operation 252, where the scheduler 102 can continue to reimage computing devices 106 in the disclosed manner.

FIG. 3A is a computing architecture diagram illustrating aspects of the operation of a supervisor 110 utilized in embodiments disclosed herein. As discussed briefly above with regard to FIG. 1, supervisor 110 is a software component that monitors state data 204 stored in a data store 108 to determine if the reimaging workflow 104 has failed for any computing devices 106. If the workflow 104 has failed for a computing device 106, the supervisor 110 initiates an auto heal job 112 for remediating failure of the re-imaging workflow 104 for the particular computing device 106.

The auto heal job 112 is a software component that determines the reason for the failure of the reimaging workflow 104 for a computing device 106 based upon the state data 204 stored in the data store 108. The auto heal job 112 can then apply one or more actions in an attempt to remediate the identified failure. For example, and without limitation, an auto heal job 112 might determine that the reimaging workflow 104 for a device 106 failed because a DHCP reservation with a valid MAC address for the device 106 is not present on a DHCP server. This might occur, for instance, if the device 106 was repaired and a network adapter with a different MAC address was installed in the machine. In this case, the auto heal job 112 can remediate the failure by updating the DHCP reservation with the correct MAC address at the DHCP server.

If the auto heal job 112 is successful, the reimaging workflow 104 for the computing device 106 can be resumed at the point in the workflow 104 at which it terminated due to the failure. In this way, the reimaging workflow 104 does not need to be restarted following a failure, thereby conserving the utilization of computing resources.

If the auto heal job 112 fails, a variable indicating the number of retries for the particular computing device 106 can be incremented. The scheduler 102 can then retry the workflow 104 for re-imaging the computing device 106 after a predefined period of time has elapsed. In this way, failures in the workflow 104 caused by conditions remediated during the predefined period of time will not occur again on a subsequent retry. For instance, a VM might be manually vacated from a device 106 during the predefined period of time, thereby enabling the workflow 104 to complete properly on a subsequent attempt. This process can be repeated until the retry count indicates that the workflow 104 has been attempted a predetermined number of times.

If the workflow 104 for re-imaging a computing device 106 fails a predetermined number of times, the supervisor 110 can store state data 114 in the data store 108 that specifies a reason, or reasons, for failure of the reimaging workflow 104, a date upon which the computing device 106 last received a security update, and potentially other information. Details regarding the utilization of this data will be described below with regard to FIGS. 4A and 4B.

FIG. 3B is a flow diagram showing a routine 350 that illustrates aspects of the operation of the supervisor 110 shown in FIGS. 1 and 3A, according to one embodiment disclosed herein. The routine 350 begins at operation 352, where the supervisor 110 monitors the state data 204 stored in the data store 108 to identify devices 106 for which the reimaging workflow 104 has failed. The routine 350 then proceeds from operation 352 to operation 354, where the supervisor 110 invokes the auto heal job 112 for a failing device 106 in an attempt to remediate the failure of the reimaging workflow 104.

From operation 354, the routine 350 proceeds to operation 356, where the supervisor 110 determines whether the auto heal job 112 was successful. If so, the routine 350 proceeds from operation 356 to operation 358, where the workflow 104 can resume at the point at which it originally failed. The routine 350 then proceeds from operation 358 to operation 352, where the process described above can be repeated.

If the auto heal job 112 was not successful, the routine 350 proceeds from operation 356 to operation 360, where the retry count for the computing device 106 for which the workflow 104 failed is incremented. The routine 350 then proceeds from operation 360 to operation 362, where the scheduler 102 retries the reimaging workflow 104 after a predetermined period of time has elapsed since the last attempt. The routine 350 then proceeds from operation 362 to operation 352, where the process described above can be repeated.

FIG. 4A is a computing architecture diagram illustrating additional aspects of the operation of the supervisor 110 shown in FIGS. 1 and 3A. As discussed briefly above, if the reimaging workflow 104 fails a predetermined number of times, the supervisor 110 can store state data 114 in the data store 108 that specifies a reason, or reasons, for failure of the reimaging workflow 104, a date 402 upon which the computing device 106 last received a security update, and potentially other information.

FIG. 4B is a flow diagram showing a routine 450 that illustrates additional aspects of the operation of the supervisor 110 shown in FIGS. 1, 3A, and 4A, according to one embodiment disclosed herein. The routine 450 begins at operation 452, where the supervisor 110 determines if the reimaging workflow 104 has failed a predetermined number of times for a particular computing device 106.

If the reimaging workflow 104 has failed a predetermined number of times for a particular computing device 106, the routine 450 proceeds from operation 454 to operation 456, where the supervisor 110 stores state data 114 in the data store 108 indicating that the workflow 104 for the device has failed and that specifies a reason, or reasons, for failure of the reimaging workflow 104. The routine 450 then proceeds from operation 456 to operation 458, where the supervisor 110 obtains the date upon which the computing device 106 last received a security update and also stores this information in the data store 108. As will be described in greater detail below with regard to FIGS. 5A and 5B, a vulnerability manager 116 can utilize this data to initiate various types of operations with regard to devices 106 for which the reimaging workflow 104 has failed a predetermined number of times.

FIG. 5A is a computing architecture diagram illustrating aspects of the operation of the vulnerability manager 116, according to one embodiment disclosed herein. As discussed briefly above, the vulnerability manager 116 is a software 16 component that monitors the state data stored in the data store 108 to identify computing devices 106 for which the reimaging workflow 104 has failed more than a predetermined number of times.

The vulnerability manager 116 can also monitor security compliance deadlines and generate trouble tickets, if necessary. For example, the security compliance deadlines might specify an amount of time within which security patches are to be applied to computing devices 106. Trouble tickets or other types of notifications can then be generated that are directed to engineering personnel for those devices 106 that have not been patched within the specified amount of time.

The vulnerability manager 116 might also, or alternately, utilize machine learning (“ML”) or other techniques to identify patterns (e.g. multiple instances of the reimaging workflow 104 failing for the same reason) based upon the state data 204 and initiate various actions based upon the identified patterns such as, for example, creating trouble tickets, generating alerts, or other types of reporting. The proper engineering team can then take action to remediate the failure such as, for example, shutting down the computing devices 106 or removing network traffic from the computing devices 106.

Once the failure of the reimaging workflow 104 for a computing device 106 has been remediated, a security compliance report 502 will be generated indicating that the computing device 106 is no longer vulnerable. When the security compliance report 502 indicates that a device 106 is no longer vulnerable, the vulnerability manager 116 will update the state data 204 for the computing devices 106 to indicate that the device 106 has been returned to its normal functioning state.

FIG. 5B is a flow diagram showing a routine 550 that illustrates additional aspects of the operation of the vulnerability manager shown in FIG. 5A, according to one embodiment disclosed herein. The routine 550 begins at operation 552, where the vulnerability manager 116 monitors security compliance deadlines and generates trouble tickets if necessary, such as, for example, when a device 106 has not been patched within a specified amount of time (e.g. 30 days from the time a patch is released). The routine 550 then proceeds from operation 552 to operation 554.

At operation 554, the vulnerability manager 116 utilizes ML or other technologies to analyze and identify patterns of failure for devices 106 for which the reimaging workflow 104 has failed. If patterns of failure can be identified, the vulnerability manager 116 can generate trouble tickets or other types of notifications to an engineering time that identify the patterns and suggest actions for remedying the failures.

From operation 554, the routine 550 proceeds to operation 556, where the vulnerability manager 116 determines whether the security compliance report 502 indicates that a device 106 has been removed from the report 502 (i.e. the device 106 is no longer vulnerable). If a device 106 has been removed from the report 502, the routine 550 proceeds from operation 558 to operation 560, where the vulnerability manager 116 updates the state data 204 for the computing device 106 to indicate that the device 106 does not require reimaging. The routine 550 then proceeds from operation 560 to operation 552, where the process described above can be repeated.

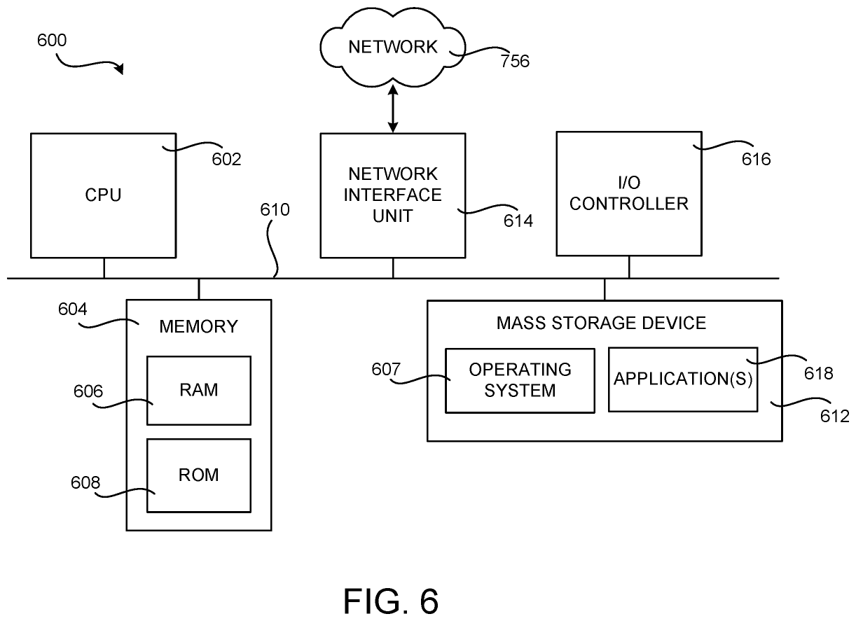

FIG. 6 shows additional details of an example computer architecture 600 for a computer capable of executing the program components described herein. For example, and without limitation, the computing architecture 600 can be utilized to execute the scheduler 102, the agents 206, the supervisor 110, and the vulnerability manager 116. The computing architecture 600 might also be utilized to implement the computing devices 106.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A firmware containing the basic routines that help to transfer information between elements within the computer architecture 600, such as during startup, can be stored in the ROM 608. The computer architecture 600 further includes a mass storage device 612 for storing an operating system 607, data, and one or more application programs 618.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media might include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes the claims, the phrase “computer storage medium,” “computer-readable storage medium” and variations thereof, does not include waves, signals, and/or other transitory and/or intangible communication media, per se.

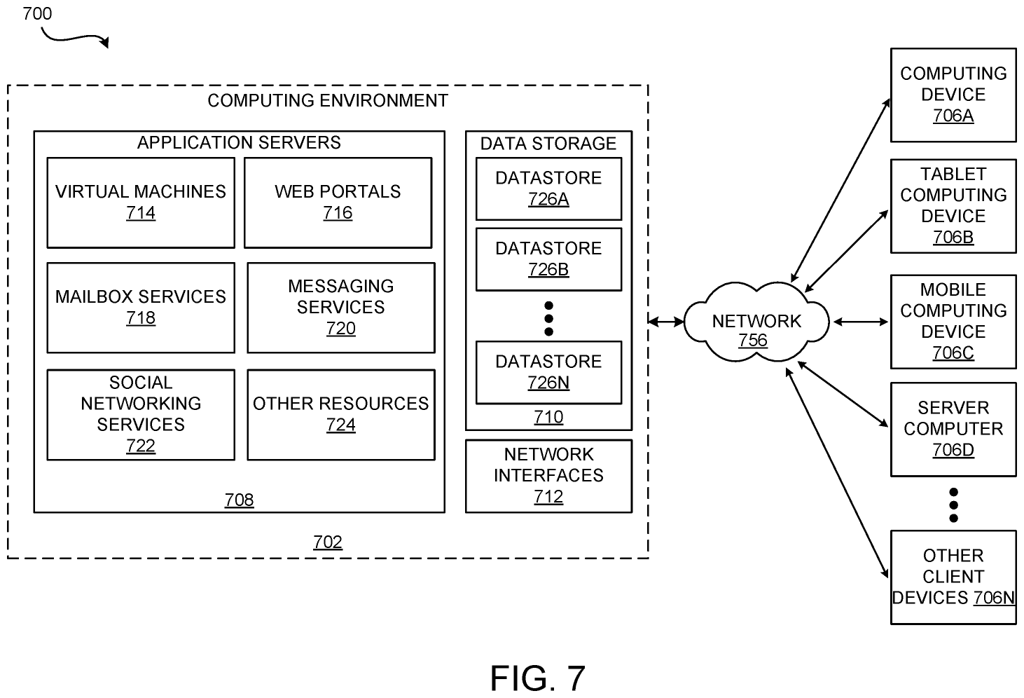

According to various configurations, the computer architecture 600 might operate in a networked environment using logical connections to remote computers through the network 756 (discussed below with regard to FIG. 7) and/or another network or networks such as those shown in FIG. 1 and described above). A computing device implementing the computer architecture 600 might connect to the network 756 through a network interface unit 614 connected to the bus 610. In this regard, it is to be appreciated that the network interface unit 614 also might be utilized to connect to other types of networks and remote computer systems.

The computer architecture 600 also might include an input/output controller 616 for receiving and processing input from a number of other devices, including a keyboard, mouse, or electronic stylus (not shown in FIG. 6). Similarly, the input/output controller 616 might provide output to a display screen, a printer, or other type of output device (also not shown in FIG. 6).

It should be appreciated that the software components described herein might, when loaded into the CPU 602 and executed, transform the CPU 602 and the overall computer architecture 600 from a general-purpose computing system into a special-purpose computing system customized to facilitate the functionality presented herein. The CPU 602 might be constructed from any number of transistors or other discrete circuit elements, which might individually or collectively assume any number of states. More specifically, the CPU 602 might operate as a finite-state machine, in response to executable instructions contained within the software modules disclosed herein. These computer-executable instructions might transform the CPU 602 by specifying how the CPU 602 transitions between states, thereby transforming the transistors or other discrete hardware elements constituting the CPU 602.

Encoding the software modules presented herein might also transform the physical structure of the computer-readable media presented herein. The specific transformation of physical structure might depend on various factors, in different implementations of this description. Examples of such factors might include, but are not limited to, the technology used to implement the computer-readable media, whether the computer-readable media is characterized as primary or secondary storage, and the like. For example, if the computer-readable media is implemented as semiconductor-based memory, the software disclosed herein might be encoded on the computer-readable media by transforming the physical state of the semiconductor memory. The software might transform the state of transistors, capacitors, or other discrete circuit elements constituting the semiconductor memory. The software also might transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of particular locations within given magnetic media. These transformations also might include altering the physical features or characteristics of particular locations within given optical media, to change the optical characteristics of those locations. Other transformations of physical media are possible, with the foregoing examples provided only to facilitate the disclosure presented herein.

In light of the above, it should be appreciated that many types of physical transformations can take place in the computer architecture 600 in order to store and execute the software components presented herein. It also should be appreciated that the computer architecture 600 can be utilized to implement other types of computing devices, including hand-held computers, embedded computer systems, smartphones, IoT devices, and other types of computing devices known to those skilled in the art. It is also contemplated that the computer architecture 600 might not include all of the components shown in FIG. 6, might include other components that are not explicitly shown in FIG. 6, or might utilize an architecture completely different than that shown in FIG. 6.

FIG. 7 depicts an illustrative distributed computing environment 700 capable of executing the software components described herein. Thus, computing devices in the distributed computing environment 700 illustrated in FIG. 7 can be utilized to execute any aspects of the software components presented herein.

According to various implementations, the distributed computing environment 700 includes a computing environment 702 operating on, in communication with, or as part of the network 704. The network 704 might be or might include the network 756, described above. The network 704 also can include various access networks. One or more client devices 706A-706N (hereinafter referred to collectively and/or generically as “clients 706”) can communicate with the computing environment 702 via the network 704 and/or other connections (not illustrated in FIG. 7).

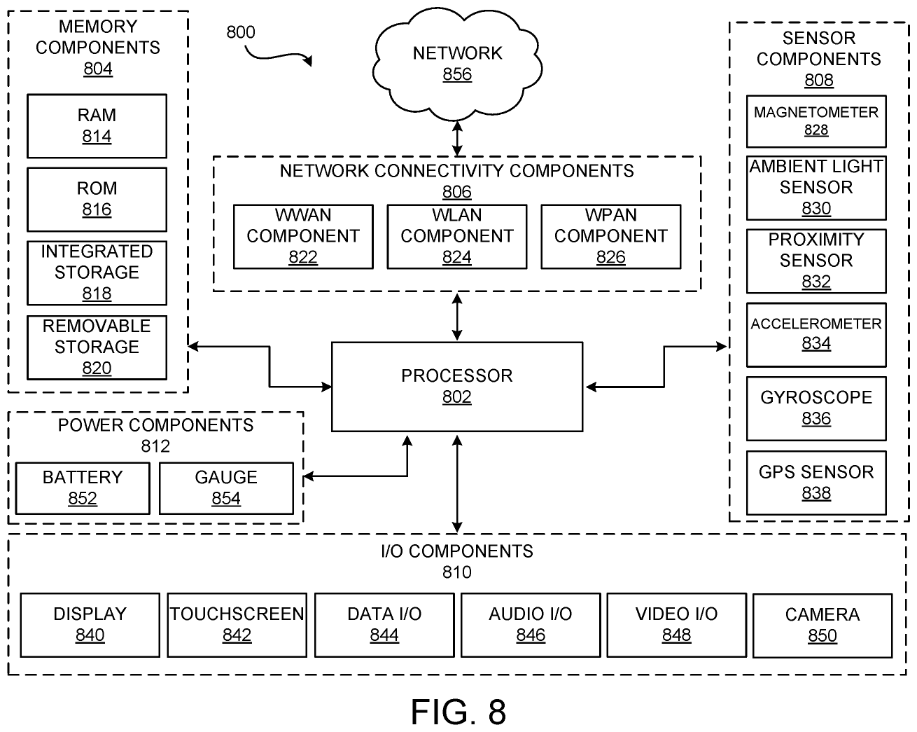

In one illustrated configuration, the clients 706 include a computing device 706A such as a laptop computer, a desktop computer, or other computing device; a tablet computing device (“tablet computing device”) 706B; a mobile computing device 706C such as a smartphone, an on-board computer, or other mobile computing device; or a server computer 706D. It should be understood that any number of devices 706 can communicate with the computing environment 702. Two example computing architectures for the devices 706 are illustrated and described herein with reference to FIGS. 6 and 8. It should be understood that the illustrated devices 706 and computing architectures illustrated and described herein are illustrative only and should not be construed as being limited in any way.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 704. The application servers 708 can host various services, virtual machines, portals, and/or other resources. The application servers 708 can also host network services and other components for implementing the services provider network 106 described above.

In the illustrated configuration, the application servers 708 host one or more virtual machines 714 for hosting applications, network services, or for providing other functionality. It should be understood that this configuration is illustrative only and should not be construed as being limiting in any way. The application servers 708 can also host or provide access to one or more portals, link pages, web sites, network services, and/or other information sites, such as web portals 716.

According to various implementations, the application servers 708 also include one or more mailbox services 718 and one or more messaging services 720. The mailbox services 718 can include electronic mail (“email”) services. The mailbox services 718 also can include various personal information management (“PIM”) services including, but not limited to, calendar services, contact management services, collaboration services, and/or other services. The messaging services 720 can include, but are not limited to, instant messaging services, chat services, forum services, and/or other communication services.

The application servers 708 also might include one or more social networking services 722. The social networking services 722 can include various social networking services including, but not limited to, services for sharing or posting status updates, instant messages, links, photos, videos, and/or other information; services for commenting or displaying interest in articles, products, blogs, or other resources; and/or other services. Other services are possible and are contemplated.

The social networking services 722 also can include commenting, blogging, and/or micro blogging services. Other services are possible and are contemplated. As shown in FIG. 7, the application servers 708 also can host other network services, applications, portals, and/or other resources (“other resources”) 724. The other resources 724 can include, but are not limited to, document sharing, rendering, or any other functionality.

As mentioned above, the computing environment 702 can include data storage 710. According to various implementations, the functionality of the data storage 710 is provided by one or more databases operating on, or in communication with, the network 704. The functionality of the data storage 710 also can be provided by one or more server computers configured to host data for the computing environment 702. The data storage 710 can include, host, or provide one or more real or virtual data stores 726A-726N (hereinafter referred to collectively and/or generically as “datastores 726”).

The datastores 726 are configured to host data used or created by the application servers 708 and/or other data. Although not illustrated in FIG. 7, the datastores 726 also can host or store web page documents, word processing documents, presentation documents, data structures, and/or other data utilized by any application program or another module. Aspects of the datastores 726 might be associated with a service for storing files.

The computing environment 702 can communicate with, or be accessed by, the network interfaces 712. The network interfaces 712 can include various types of network hardware and software for supporting communications between two or more computing devices including, but not limited to, the clients 706 and the application servers 708. It should be appreciated that the network interfaces 712 also might be utilized to connect to other types of networks and/or computer systems.

It should be understood that the distributed computing environment 700 described herein can implement aspects of at least some of the software elements described herein with any number of virtual computing resources and/or other distributed computing functionality that can be configured to execute any aspects of the software components disclosed herein.

Turning now to FIG. 8, another illustrative computing device architecture 800 for a computing device that is capable of executing the software components described herein will be discussed. The computing device architecture 800 is applicable to computing devices that facilitate mobile computing due, in part, to form factor, wireless connectivity, and/or battery-powered operation.

The computing device architecture 800 is applicable to any of the clients 706 shown in FIG. 7. Moreover, aspects of the computing device architecture 800 might be applicable to traditional desktop computers, portable computers (e.g., laptops, notebooks, ultra-portables, and netbooks), server computers, and other computer systems, such as described herein with reference to FIG. 6.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individual components illustrated in FIG. 8, the components can interact to carry out device functions. In some configurations, the components are arranged so as to communicate via one or more hardware busses (not shown).

The processor 802 includes a central processing unit (“CPU”) configured to process data, execute computer-executable instructions of one or more application programs, and communicate with other components of the computing device architecture 800 in order to perform various functionality described herein. The processor 802 might be utilized to execute aspects of the software components presented herein and, particularly, software components for implementing the functionality provided by the supervisor 110, the scheduler 102, and the vulnerability manager 116.

In some configurations, the processor 802 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, 4K, and higher resolution), video games, three-dimensional (“3D”) modeling applications, and the like. In some configurations, the processor 802 is configured to communicate with a discrete GPU (not shown). In any case, the CPU and GPU might be configured in accordance with a co-processing CPU/GPU computing model, wherein the sequential part of an application executes on the CPU and the computationally-intensive part is accelerated by the GPU.

In some configurations, the processor 802 is, or is included in, a system-on-chip (“SoC”) along with one or more of the other components described herein below. For example, the SoC might include the processor 802, a GPU, one or more of the network connectivity components 806, and one or more of the sensor components 808. In some configurations, the processor 802 is fabricated, in part, utilizing a package-on-package (“PoP”) integrated circuit packaging technique. The processor 802 might be a single core or multi-core processor.

The processor 802 might implement an ARM architecture, available for license from ARM HOLDINGS of Cambridge, United Kingdom. Alternatively, the processor 802 might implement an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a RAM 814, a ROM 816, an integrated storage memory (“integrated storage”) 818, and a removable storage memory (“removable storage”) 820. In some configurations, the RAM 814 or a portion thereof, the ROM 816 or a portion thereof, and/or some combination of the RAM 814 and the ROM 816 is integrated in the processor 802. In some configurations, the ROM 816 is configured to store a firmware, an operating system or a portion thereof (e.g., operating system kernel), and/or a bootloader to load an operating system kernel from the integrated storage 818 and/or the removable storage 820.

The integrated storage 818 can include a solid-state memory, a hard disk, or a combination of solid-state memory and a hard disk. The integrated storage 818 might be soldered or otherwise connected to a logic board upon which the processor 802 and other components described herein also might be connected. As such, the integrated storage 818 is integrated in the computing device. The integrated storage 818 is configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available as a total combined storage capacity. In some configurations, the total combined capacity of the integrated storage 818 and the removable storage 820 is shown to a user instead of separate storage capacities for the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 might be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system 607. According to various configurations, the operating system includes, but is not limited to the WINDOWS operating system from Microsoft Corporation, IOS from Apple Inc. of Cupertino, Calif., and ANDROID OS from Google Inc. of Mountain View, Calif. Other operating systems are contemplated.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from the network 856 or another network, which might be a WWAN, a WLAN 104, or a WPAN. Although only the network 856 is illustrated, the network connectivity components 806 might facilitate simultaneous communication with multiple networks, including the network 756 of FIG. 6. For example, the network connectivity components 806 might facilitate simultaneous communications with multiple networks via one or more of a WWAN, a WLAN, or a WPAN. The network 856 might also be or might include a WWAN, such as a mobile telecommunications network utilizing one or more mobile telecommunications technologies to provide voice and/or data services to a computing device utilizing the computing device architecture 800 via the WWAN component 822.

In some configurations, the WWAN component 822 is configured to provide dual- multi-mode connectivity to the network 856. For example, the WWAN component 822 might be configured to provide connectivity to the network 856, wherein the network 856 provides service via GSM and UMTS technologies, or via some other combination of technologies. Alternatively, multiple WWAN components 822 might be utilized to perform such functionality, and/or provide additional functionality to support other non-compatible technologies (i.e., incapable of being supported by a single WWAN component). The WWAN component 822 might facilitate similar connectivity to multiple networks (e.g., a UMTS network and an LTE network).

The network 856 might be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 856 via the WI-FI access points. Such connections might be secured via various encryption technologies including, but not limited to, WI-FI Protected Access (“WPA”), WPA2, Wired Equivalent Privacy (“WEP”), and the like.

The network 856 might be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 828, an ambient light sensor 830, a proximity sensor 832, an accelerometer 834, a gyroscope 836, and a Global Positioning System sensor (“GPS sensor”) 838. It is contemplated that other sensors, such as, but not limited to, temperature sensors or shock detection sensors, also might be incorporated in the computing device architecture 800.

The magnetometer 828 is configured to measure the strength and direction of a magnetic field. In some configurations the magnetometer 828 provides measurements to a compass application program stored within one of the memory components 804 in order to provide a user with accurate directions in a frame of reference including the cardinal directions, north, south, east, and west. Similar measurements might be provided to a navigation application program that includes a compass component. Other uses of measurements obtained by the magnetometer 828 are contemplated.

The ambient light sensor 830 is configured to measure ambient light. In some configurations, the ambient light sensor 830 provides measurements to an application program stored within one of the memory components 804 in order to automatically adjust the brightness of a display (described below) to compensate for low-light and high-light environments. Other uses of measurements obtained by the ambient light sensor 830 are contemplated.

The proximity sensor 832 is configured to detect the presence of an object or thing in proximity to the computing device without direct contact. In some configurations, the proximity sensor 832 detects the presence of a user's body (e.g., the user's face) and provides this information to an application program stored within one of the memory components 804 that utilizes the proximity information to enable or disable some functionality of the computing device. For example, a telephone application program might automatically disable a touchscreen (described below) in response to receiving the proximity information so that the user's face does not inadvertently end a call or enable/disable other functionality within the telephone application program during the call. Other uses of proximity as detected by the proximity sensor 832 are contemplated.

The accelerometer 834 is configured to measure proper acceleration. In some configurations, output from the accelerometer 834 is used by an application program as an input mechanism to control some functionality of the application program. For example, the application program might be a video game in which a character, a portion thereof, or an object is moved or otherwise manipulated in response to input received via the accelerometer 834. In some configurations, output from the accelerometer 834 is provided to an application program for use in switching between landscape and portrait modes, calculating coordinate acceleration, or detecting a fall. Other uses of the accelerometer 834 are contemplated.

The gyroscope 836 is configured to measure and maintain orientation. In some configurations, output from the gyroscope 836 is used by an application program as an input mechanism to control some functionality of the application program. For example, the gyroscope 836 can be used for accurate recognition of movement within a 3D environment of a video game application or some other application. In some configurations, an application program utilizes output from the gyroscope 836 and the accelerometer 834 to enhance control of some functionality of the application program. Other uses of the gyroscope 836 are contemplated.

The GPS sensor 838 is configured to receive signals from GPS satellites for use in calculating a location. The location calculated by the GPS sensor 838 might be used by any application program that requires or benefits from location information. For example, the location calculated by the GPS sensor 838 might be used with a navigation application program to provide directions from the location to a destination or directions from the destination to the location. Moreover, the GPS sensor 838 might be used to provide location information to an external location-based service, such as E911 service. The GPS sensor 838 might obtain location information generated via WI-FI, WIMAX, and/or cellular triangulation techniques utilizing one or more of the network connectivity components 806 to aid the GPS sensor 838 in obtaining a location fix. The GPS sensor 838 might also be used in Assisted GPS (“A-GPS”) systems.

The I/O components 810 include a display 840, a touchscreen 842, a data I/O interface component (“data I/O”) 844, an audio I/O interface component (“audio I/O”) 846, a video I/O interface component (“video I/O”) 848, and a camera 850. In some configurations, the display 840 and the touchscreen 842 are combined. In some configurations two or more of the data I/O component 844, the audio I/O component 846, and the video I/O component 848 are combined. The I/O components 810 might include discrete processors configured to support the various interfaces described below or might include processing functionality built-in to the processor 802.

The display 840 is an output device configured to present information in a visual form. In particular, the display 840 might present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 840 is a liquid crystal display (“LCD”) utilizing any active or passive matrix technology and any backlighting technology (if used). In some configurations, the display 840 is an organic light emitting diode (“OLED”) display. Other display types are contemplated.

The data I/O interface component 844 is configured to facilitate input of data to the computing device and output of data from the computing device. In some configurations, the data I/O interface component 844 includes a connector configured to provide wired connectivity between the computing device and a computer system, for example, for synchronization operation purposes. The connector might be a proprietary connector or a standardized connector such as USB, micro-USB, mini-USB, USB-C or the like. In some configurations, the connector is a dock connector for docking the computing device with another device such as a docking station, audio device (e.g., a digital music player), or video device.

The audio I/O interface component 846 is configured to provide audio input and/or output capabilities to the computing device. In some configurations, the audio I/O interface component 846 includes a microphone configured to collect audio signals. In some configurations, the audio I/O interface component 846 includes a headphone jack configured to provide connectivity for headphones or other external speakers. In some configurations, the audio I/O interface component 846 includes a speaker for the output of audio signals. In some configurations, the audio I/O interface component 846 includes an optical audio cable out.

The video I/O interface component 848 is configured to provide video input and/or output capabilities to the computing device. In some configurations, the video I/O interface component 848 includes a video connector configured to receive video as input from another device (e.g., a video media player such as a DVD or BLURAY player) or send video as output to another device (e.g., a monitor, a television, or some other external display). In some configurations, the video I/O interface component 848 includes a High-Definition Multimedia Interface (“HDMI”), mini-HDMI, micro-HDMI, DisplayPort, or proprietary connector to input/output video content. In some configurations, the video I/O interface component 848 or portions thereof is combined with the audio I/O interface component 846 or portions thereof. The device illustrated in FIG. 8 can also be headless (i.e. without a display).

The camera 850 can be configured to capture still images and/or video. The camera 850 might utilize a charge coupled device (“CCD”) or a complementary metal oxide semiconductor (“CMOS”) image sensor to capture images. In some configurations, the camera 850 includes a flash to aid in taking pictures in low-light environments. Settings for the camera 850 might be implemented as hardware or software buttons.

Although not illustrated, one or more hardware buttons might also be included in the computing device architecture 800. The hardware buttons might be used for controlling some operational aspects of the computing device. The hardware buttons might be dedicated buttons or multi-use buttons. The hardware buttons might be mechanical or sensor-based.

The illustrated power components 812 include one or more batteries 852, which can be connected to a battery gauge 854. The batteries 852 might be rechargeable or disposable. Rechargeable battery types include, but are not limited to, lithium polymer, lithium ion, nickel cadmium, and nickel metal hydride. Each of the batteries 852 might be made of one or more cells.

The battery gauge 854 can be configured to measure battery parameters such as current, voltage, and temperature. In some configurations, the battery gauge 854 is configured to measure the effect of a battery's discharge rate, temperature, age and other factors to predict remaining life within a certain percentage of error. In some configurations, the battery gauge 854 provides measurements to an application program that is configured to utilize the measurements to present useful power management data to a user. Power management data might include one or more of a percentage of battery used, a percentage of battery remaining, a battery condition, a remaining time, a remaining capacity (e.g., in watt hours), a current draw, and a voltage.

The power components 812 might also include a power connector, which might be combined with one or more of the aforementioned I/O components 810. The power components 812 might interface with an external power system or charging equipment via an I/O component.

It is to be appreciated that the computing architectures and networks shown in FIGS. 6-8 have been simplified for ease of discussion. It should also be appreciated that the disclosed computing architectures and networks can include and utilize more, less, different, or alternate computing components, devices, software programs, networking devices, and other components not specifically described herein.

The disclosure presented herein also encompasses the subject matter set forth in the following clauses:

Clause 1. A computer-implemented method performed by a computing device, the method comprising: initiating a workflow for re-imaging a computing device; during execution of the workflow, storing state data describing a state of the re-imaging of the computing device in a data store; determining if the state data in the data store indicates that the re-imaging of the computing device has failed; if the state data indicates that re-imaging of the computing device has failed, initiating an auto heal job for remediating failure of the re-imaging of the computing device; determining if the auto heal job has failed; and responsive to determining that the auto heal job has failed, causing the workflow for re-imaging the computing device to be retried after a predefined period of time has elapsed.

Clause 2. The computer-implemented method of clause 1, further comprising causing the workflow for re-imaging the computing device to resume responsive to determining that the auto heal job has succeeded.

Clause 3. The computer-implemented method of any of clauses 1 or 2, further comprising: determining the workflow for re-imaging the computing device failed a predetermined number of times; and responsive to determining the workflow for re-imaging the computing device failed a predetermined number of times, storing state data in the data store for the computing device specifying a reason for failure of the workflow and a date upon which the computing device last received a software patch.

Clause 4. The computer-implemented method of any of clauses 1-3, further comprising: identifying one or more patterns based upon the state data; and initiating one or more actions based upon the identified patterns.

Clause 5. The computer-implemented method of any of clauses 1-4, further comprising shutting down the computing device or causing network traffic to be removed from the computing device responsive to determining the workflow for re-imaging the computing device has failed a predetermined number of times.

Clause 6. The computer-implemented method of any of clauses 1-5, wherein the workflow for re-imaging the computing device is performed by a plurality of software agents under control of a scheduler.

Clause 7. The computer-implemented method of any of clauses 1-6, wherein the software agents provide status messages comprising data describing a status of the workflow for re-imaging the computing device to the scheduler, and wherein the scheduler is configured to update the state data in the data store based upon the status messages.

Clause 8. A computer-readable storage media having computer-executable instructions stored thereupon which, when executed by a computer, cause the computer to: store state data describing a state of the re-imaging of a computing device in a data store during execution of a workflow for re-imaging the computing device, determine if the state data in the data store indicates that the re-imaging of the computing device has failed; initiate an auto heal job for remediating failure of the re-imaging of the computing device if the state data indicates that re-imaging of the computing device has failed; determine that the auto heal job has failed; and responsive to determining that the auto heal job has failed, cause the workflow for re-imaging the computing device to be retried after a predefined period of time has elapsed.

Clause 9. The computer-readable storage media of clause 8, having further computer-executable instructions stored thereupon which, when executed by the computer, cause the computer to resume the workflow for re-imaging the computing device responsive to determine the auto heal job has succeeded.

Clause 10. The computer-readable storage media of any of clauses 8 or 9, having further computer-executable instructions stored thereupon which, when executed by the computer, cause the computer to: determine the workflow for re-imaging the computing device failed a predetermined number of times; and responsive to determining the workflow for re-imaging the computing device failed a predetermined number of times, store state data in the data store for the computing device specifying a reason for failure of the workflow and a date upon which the computing device last received a software patch.

Clause 11. The computer-readable storage media of any of clauses 8-10, having further computer-executable instructions stored thereupon which, when executed by the computer, cause the computer to: identify one or more patterns based upon the state data; and initiate one or more actions based upon the identified patterns.

Clause 12. The computer-readable storage media of any of clauses 8-11, having further computer-executable instructions stored thereupon which, when executed by the computer, cause the computer to shut down the computing device or cause network traffic to be removed from the computing device responsive to determining the workflow for re-imaging the computing device has failed a predetermined number of times.

Clause 13. The computer-readable storage media of any of clauses 8-12, wherein the workflow for re-imaging the computing device is performed by a plurality of software agents under control of a scheduler.

Clause 14. The computer-readable storage media of any of clauses 8-13, wherein the software agents provide status messages comprising data describing a status of the workflow for re-imaging the computing device to the scheduler, and wherein the scheduler is configured to update the state data in the data store based upon the status messages.

Clause 15. A computing device, comprising: a processor; a network interface unit; and a computer-readable storage media having instructions stored thereupon which, when executed by the processor, cause the computing device to: store state data describing a state of the re-imaging of a computing device in a data store during execution of a workflow for re-imaging the computing device, determine if the state data in the data store indicates that the re-imaging of the computing device has failed; initiate an auto heal job for remediating failure of the re-imaging of the computing device if the state data indicates that re-imaging of the computing device has failed; determine that the auto heal job has failed; and responsive to determining that the auto heal job has failed, cause the workflow for re-imaging the computing device to be retried after a predefined period of time has elapsed.

Clause 16. The computing device of clause 15, wherein the computer-readable storage media has further computer-executable instructions stored thereupon which, when executed by the computer, cause the computer to resume the workflow for re-imaging the computing device responsive to determine the auto heal job has succeeded.

Clause 17. The computing device of any of clauses 15 or 16, wherein the computer-readable storage media has further computer-executable instructions stored thereupon which, when executed by the computer, cause the computer to: determine the workflow for re-imaging the computing device failed a predetermined number of times; and responsive to determining the workflow for re-imaging the computing device failed a predetermined number of times, store state data in the data store for the computing device specifying a reason for failure of the workflow and a date upon which the computing device last received a software patch.

Clause 18. The computing device of any of clauses 15-17, wherein the computer-readable storage media has further computer-executable instructions stored thereupon which, when executed by the computer, cause the computer to: identify one or more patterns based upon the state data; and initiate one or more actions based upon the identified patterns.

Clause 19. The computing device of any of clauses 15-18, wherein the computer-readable storage media has further computer-executable instructions stored thereupon which, when executed by the computer, cause the computer to shut down the computing device or cause network traffic to be removed from the computing device responsive to determining the workflow for re-imaging the computing device has failed a predetermined number of times.

Clause 20. The computing device of any of clauses 15-19, wherein the workflow for re-imaging the computing device is performed by a plurality of software agents under control of a scheduler.

Based on the foregoing, it should be appreciated that technologies have been disclosed herein for supervised reimaging of vulnerable computing devices with prioritization, auto healing, and pattern detection. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method performed by a computing device, the method comprising:
initiating a workflow for re-imaging a computing device;
during execution of the workflow, storing state data describing a state of the re-imaging of the computing device in a data store;
determining if the state data in the data store indicates that the re-imaging of the computing device has failed;
if the state data indicates that re-imaging of the computing device has failed, initiating an auto heal job for remediating failure of the re-imaging of the computing device;
determining if the auto heal job has failed; and
responsive to determining that the auto heal job has failed, causing the workflow for re-imaging the computing device to be retried after a predefined period of time has elapsed.

2. The computer-implemented method of claim 1, further comprising causing the workflow for re-imaging the computing device to resume responsive to determining that the auto heal job has succeeded.

3. The computer-implemented method of claim 1, further comprising:
determining the workflow for re-imaging the computing device failed a predetermined number of times; and
responsive to determining the workflow for re-imaging the computing device failed a predetermined number of times, storing state data in the data store for the computing device specifying a reason for failure of the workflow and a date upon which the computing device last received a software patch.

4. The computer-implemented method of claim 3, further comprising:
identifying one or more patterns based upon the state data; and
initiating one or more actions based upon the identified patterns.

5. The computer-implemented method of claim 3, further comprising shutting down the computing device or causing network traffic to be removed from the computing device responsive to determining the workflow for re-imaging the computing device has failed a predetermined number of times.

6. The computer-implemented method of claim 1, wherein the workflow for re-imaging the computing device is performed by a plurality of software agents under control of a scheduler.

7. The computer-implemented method of claim 6, wherein the software agents provide status messages comprising data describing a status of the workflow for re-imaging the computing device to the scheduler, and wherein the scheduler is configured to update the state data in the data store based upon the status messages.

8. A computer-readable storage media having computer-executable instructions stored thereupon which, when executed by a computer, cause the computer to:
store state data describing a state of the re-imaging of a computing device in a data store during execution of a workflow for re-imaging the computing device, determine if the state data in the data store indicates that the re-imaging of the computing device has failed;
initiate an auto heal job for remediating failure of the re-imaging of the computing device if the state data indicates that re-imaging of the computing device has failed;
determine that the auto heal job has failed; and
responsive to determining that the auto heal job has failed, cause the workflow for re-imaging the computing device to be retried after a predefined period of time has elapsed.

9. The computer-readable storage media of claim 8, having further computer-executable instructions stored thereupon which, when executed by the computer, cause the computer to resume the workflow for re-imaging the computing device responsive to determine the auto heal job has succeeded.

10. The computer-readable storage media of claim 8, having further computer-executable instructions stored thereupon which, when executed by the computer, cause the computer to:
determine the workflow for re-imaging the computing device failed a predetermined number of times; and
responsive to determining the workflow for re-imaging the computing device failed a predetermined number of times, store state data in the data store for the computing device specifying a reason for failure of the workflow and a date upon which the computing device last received a software patch.

11. The computer-readable storage media of claim 10, having further computer-executable instructions stored thereupon which, when executed by the computer, cause the computer to:
identify one or more patterns based upon the state data; and
initiate one or more actions based upon the identified patterns.

12. The computer-readable storage media of claim 10, having further computer-executable instructions stored thereupon which, when executed by the computer, cause the computer to shut down the computing device or cause network traffic to be removed from the computing device responsive to determining the workflow for re-imaging the computing device has failed a predetermined number of times.

13. The computer-readable storage media of claim 8, wherein the workflow for re-imaging the computing device is performed by a plurality of software agents under control of a scheduler.

14. The computer-readable storage media of claim 13, wherein the software agents provide status messages comprising data describing a status of the workflow for re-imaging the computing device to the scheduler, and wherein the scheduler is configured to update the state data in the data store based upon the status messages.

15. A computing device, comprising:
a processor;
a network interface unit; and
a computer-readable storage media having instructions stored thereupon which, when executed by the processor, cause the computing device to:
store state data describing a state of the re-imaging of a computing device in a data store during execution of a workflow for re-imaging the computing device,
determine if the state data in the data store indicates that the re-imaging of the computing device has failed;
initiate an auto heal job for remediating failure of the re-imaging of the computing device if the state data indicates that re-imaging of the computing device has failed;
determine that the auto heal job has failed; and
responsive to determining that the auto heal job has failed, cause the workflow for re-imaging the computing device to be retried after a predefined period of time has elapsed.

16. The computing device of claim 15, wherein the computer-readable storage media has further computer-executable instructions stored thereupon which, when executed by the computer, cause the computer to resume the workflow for re-imaging the computing device responsive to determine the auto heal job has succeeded.

17. The computing device of claim 15, wherein the computer-readable storage media has further computer-executable instructions stored thereupon which, when executed by the computer, cause the computer to:
determine the workflow for re-imaging the computing device failed a predetermined number of times; and
responsive to determining the workflow for re-imaging the computing device failed a predetermined number of times, store state data in the data store for the computing device specifying a reason for failure of the workflow and a date upon which the computing device last received a software patch.

18. The computing device of claim 17, wherein the computer-readable storage media has further computer-executable instructions stored thereupon which, when executed by the computer, cause the computer to:
identify one or more patterns based upon the state data; and
initiate one or more actions based upon the identified patterns.

19. The computing device of claim 17, wherein the computer-readable storage media has further computer-executable instructions stored thereupon which, when executed by the computer, cause the computer to shut down the computing device or cause network traffic to be removed from the computing device responsive to determining the workflow for re-imaging the computing device has failed a predetermined number of times.

20. The computing device of claim 15, wherein the workflow for re-imaging the computing device is performed by a plurality of software agents under control of a scheduler.
